(19) United States
(12) Patent Application Publication
(10) Pub. No.: US 2005/0140041 A1
(43) Pub. Date: Jun. 30, 2005

(54) Synthetic roofing and siding material

(76) Inventor: Manish Seth, Burnaby (CA)

Correspondence Address: Larry B. Guernsey, Esq.;Intellectual Property Law Offices, Suite 660, 1901 S. Bascom Avenue, Campbell, CA, 95008, US

(21) Appl. No.: 10/749,341

(22) Filed: Dec. 31, 2003

(51) Int. Cl. B29C 47/00

(52) U.S. Cl. 264/75; 264/211; 523/171

(57) ABSTRACT

A synthetic building material formulated for commercial extrusion processing is disclosed. The material includes filler material of proportions of 65%-90% of overall composition, thermoplastic resin of proportions of 10%-35% of overall composition, and processing stabilizer/lubricant which is chosen from a group consisting of metallic stearate, hydrocarbons, fatty acids, esters, amides fluoropolymers, silicones, and boron nitride.

### TECHNICAL FIELD

The present invention relates generally to building materials by providing a high degree of weatherability and an aesthetically pleasing appearance especially for roofing and siding applications. More specifically, the invention relates to a novel composition of a building material comprised of recycled or virgin thermoplastic, mineral filler material and various other additives for which a Class A fire rating for roofing can be achieved.

### BACKGROUND ART

Many types of roofing materials are available in the market, and some of the more popular types include shake, shingles and natural slate. Natural slate has long been a popular roofing material due to its attractive appearance and durability and also because it possesses other highly desirable properties such as being fireproof and waterproof. Natural slate, however, is also very expensive and as a result is normally used for roofing in only the most expensive of houses and in other structures where the increased cost can be justified. Slate is a brittle material and can be cracked or broken rather easily. Natural slate tiles are quite durable; however their disadvantage is that they require a substantial amount of labor in their installation and can break on impact. Natural slate tiles are inherently fragile and suffer much breakage during shipping and installation. Natural slate tiles are fragile even after installation on the roof and can be damaged by foot traffic on the roof. Tiles tend to be excessively heavy and dangerous in earthquakes and high winds, and will fall through in the event of a fire. Since tiles are so heavy, they are also expensive to ship. Also, due to the weight of natural slate, extra structural support is required for slate roofs when compared to cedar shake or shingle roofs or asphalt roofs (additional structural support is also required for concrete tile roofs).

Wood shakes and shingles are subject to breakage, rot and loss of coloration. Their cost is high and they are labor intensive to install. Furthermore, wood shakes and shingles can be relatively heavy and are flammable, porous and cannot withstand relatively high wind velocity. A disadvantage of wooden shake shingles is that they absorb moisture and swell. Therefore, they must be applied in a spaced-apart arrangement to allow room for expansion. Because of the propensity of wooden shake shingles to absorb water, they tend to curl and not remain flat on the roof.

One of the most desirable properties of any roofing material is to be able to resist fires. This is particularly true in regions having a hot and dry climate, although fire resistance is desirable everywhere. A particularly important aspect of fire resistance is the ability of the roofing material to prevent a fire, or a source of heat such as a burning ember, from burning through the roofing material to thereby expose the roof deck or interior of the building to the fire. Metal roofs and clay tile roofs have inherent advantages in fire resistance over wood shake shingle roofs. Asphalt shingles contain greater than 60% filler of finely ground inorganic particulate matter and therefore are sufficiently fire resistant to obtain a Class A fire rating when measured by appropriate tests.

Additionally, with consciousness increasing about the importance of recycling to consume fewer materials in a world of dwindling resources, it is desirable that recycled materials be used as a portion of the synthetic roofing materials. This will provide a market for recycled materials and recycling practices will be encouraged if there is a known commercial application for these materials, once they have been collected. There have been pervious attempts to make roofing material with recycled plastic filler.

A number of prior art patents have attempted to meet these needs. U.S. Pat. No. 6,114,007 discloses a flame retardant formulation. U.S. Pat. No. 5,992,116 discloses a formulation for PVC and wood fiber. U.S. Pat. No. 5,648,144 discloses a synthetic slate roofing member that uses a synthetic formulation. U.S. Pat. No. 4,307,552 discloses a formulation that is 30-60% plastic and 20-60% filler. U.S. Pat. No. 6,408,593 discloses a synthetic shingle composition that uses rubber as its primary component. Canadian Pat. No. 2297608 discloses a formulation of 50-70% gypsum and dolomite and the balance polyethylene.

Although synthetic roofing materials provide advantages of being moldable, light in weight and relatively inexpensive; they have not, in general, been fully acceptable in terms of performance because those materials often lack the durability required for roofing applications. As a example, in general, previous invented synthetic roofing materials has high concentration of plastic or rubber content in the formulation which directly affects the fire resistance of final product because plastic material lacks the fire resistant qualities. In some cases, fire resistance of the product was enhanced by adding a high concentration of flame retardant, which in turn, makes the product much more expensive. In the present invention, we overcome this problem by incorporating high concentration of mineral filler into the formulation. Mineral filler being inflammable generates high resistance to fire and require least amount of flame retardant.

Many of these synthetic materials are formulated to be formed by molding processes, among them, U.S. Pat. No. 5,615,523 to Wells, et al., which discloses using a mixture of organic plastic resin in proportions of 16-24% organic plastic and 76 to 84% of inorganic filler material. The mixture is then molded by such processes as injection molding or transfer molding.

However, there are advantages to forming plastic or plastic-like materials through extrusion processes. Advantages of extrusion process over injection molding process include 1) lower capital cost for extrusion machinery, 2) lower capital cost for dies/molds, 3) higher length to diameter ratio (L/D) for extrusion process which provides various advantages like increased output rate, lower melt temperatures, less pressure and temperature variations and improved mixing., and 4) higher production as there can be constant output with extrusion compared to intermittent production with injection molding because injection molding process is limited by cycle time. 5) highly viscous materials can be handled with extrusion process while in injection molding lower viscosity of the material is necessary to be able to fill the molds. 6) multi-layered products can be manufactured using co-extrusion process which is not feasible with injection molding process.

Despite these advantages, flow characteristics of raw materials are generally not suitable for extrusion process without carefully devised additives to the raw material, and thus the extrusion process has not been used to its potential as a commercial forming process.

It has been found that thermoplastic resin in combination with a high proportion of mineral filler cannot be extruded through conventional extrusion processes. Conventional extrusion processes are also complicated by the introduction of high filler content into thermoplastic resin because of the viscosity differences and as well as the different flow abilities of the materials. A mixture having a high proportion of mineral filler generally cannot be extruded through conventional extrusion process because raw materials are too viscous to process without a stabilizer/lubricant, and mixing of raw materials is insufficient without a stabilizer/lubricant. In order to produce a mixture that can be formed by extrusion as a practical commercial operation, it would also be desirable to provide better surface wetting between the surface of the mineral filler and the thermoplastic resin, and to provide a lubricating effect to aid in processing of a formulation with relatively high filler content.

It would be desirable to have a synthetic building material which could overcome the disadvantages of previous attempts to produce synthetic materials. Thus, there is a need for a synthetic roofing material that is sturdy, lightweight, inexpensive and fire-resistant, which can be made using partially recycled materials, and which can be formed by commercial extrusion processes.

### DISCLOSURE OF INVENTION

Accordingly, it is an object of the present invention to provide a roofing material that is light-weight.

Another object of the invention is to provide a roofing material that is inexpensive.

And another object of the invention is to provide a roofing material that is sturdy and not brittle.

A further object of the present invention is to provide a roofing material that is easy to extrude using commercial extrusion equipment.

An additional object of the present invention is to provide a roofing material that uses recycled materials as a portion of its composition.

Yet another object of the present invention is to provide a roofing material that is fire-resistant.

A yet further object of the present invention is to provide a roofing material that is resistant to weathering.

Briefly, one preferred embodiment of the present invention is a synthetic building material formulated for commercial extrusion processing. The material includes filler material of proportions of 65%-90% of overall composition, thermoplastic resin of proportions of 10%-35% of overall composition, and processing stabilizer/lubricant is selected from a group consisting of metallic stearate, hydrocarbons, fatty acids, esters, amides fluoropolymers, silicones, and boron nitride.

Also disclosed are a formulation for synthetic building material and a method for producing it.

An advantage of the present invention is that it presents a formulation that is well-suited to commercial extrusion processes.

Another advantage of the present invention is that a formulation is presented which includes a stabilizer/lubricant which acts to reduce the adverse effects of viscosity differences and as well as the different flow abilities of the materials.

A further advantage of the present invention is that it presents a formulation which provides better surface wetting between the surface of the mineral filler and the thermoplastic resin.

A yet further advantage is that it presents a formulation which provides a lubricant to aid in processing of a formulation with relatively high filler content.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 shows a perspective view of synthetic slate panels made from the synthetic building material of the present invention;

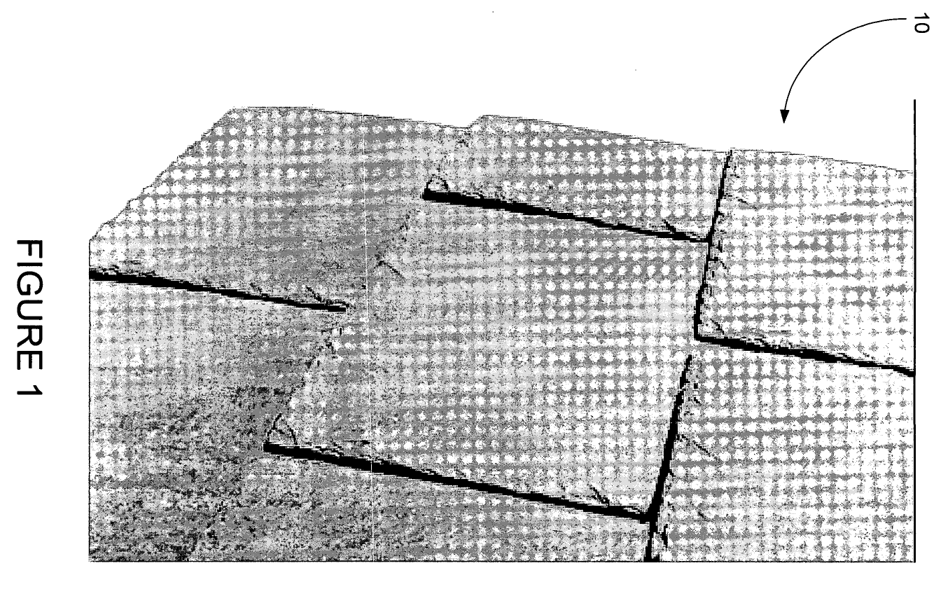

FIG. 2 shows a plan view of a single synthetic slate panel made from the synthetic building material of the present invention; and

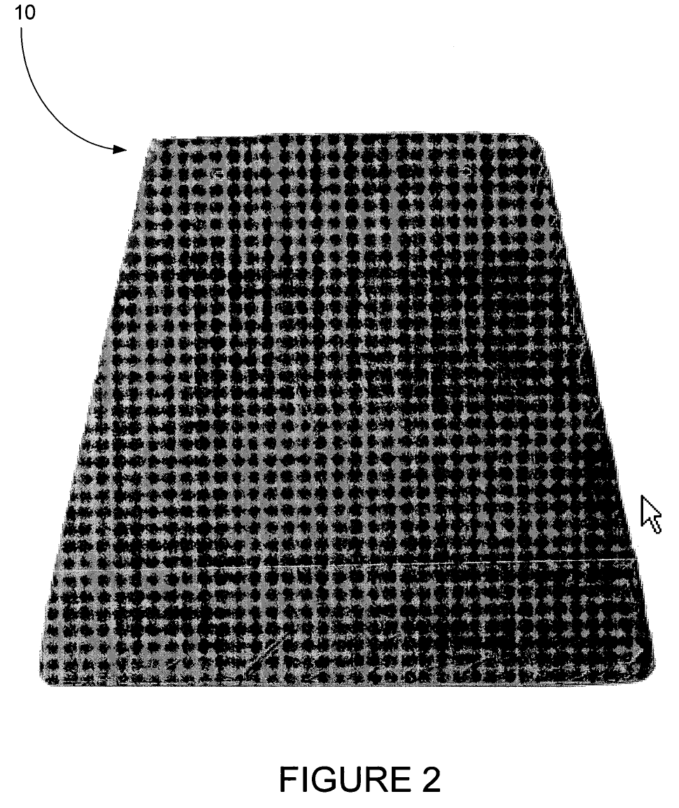

FIG. 3 shows a perspective view of synthetic slate panels made from the synthetic building material of the present invention used in a roofing application.

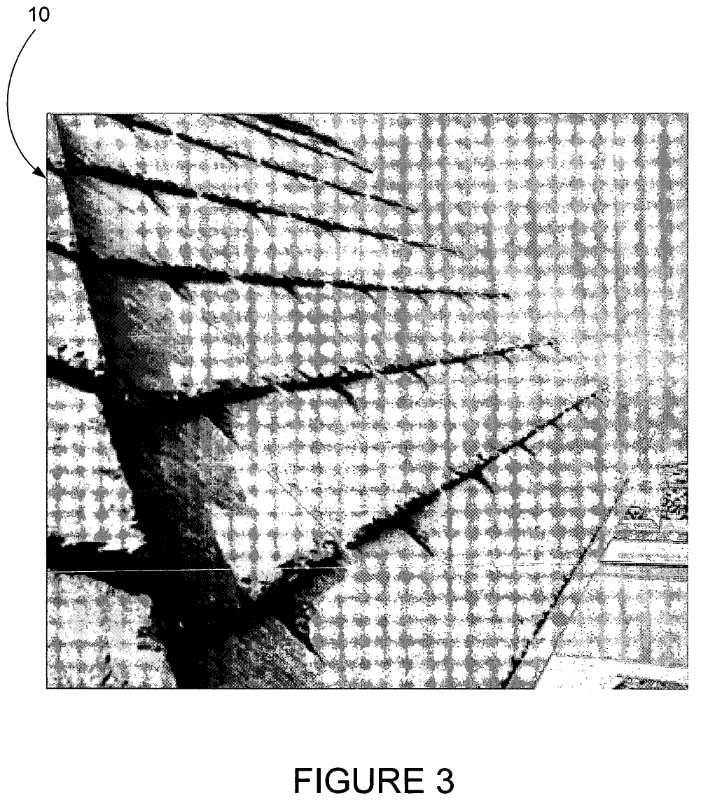

### BEST MODE FOR CARRYING OUT THE INVENTION

The present invention is a method of producing synthetic building materials 10 which can be used as roofing and sliding for structures, a formulation for synthetic building materials and panels of synthetic material made from the disclosed formulation.

The suitability of building materials is judged on the basis of many different qualities. Some of these are formalized as criteria which are tested by the International Council of Building Officials (ICBO). These criteria are discussed below, but generally, building materials are preferred to have the qualities of being lightweight, inexpensive, sturdy, waterproof and weather-resistant, easily formed into panels or other shapes, and fire-resistant. In addition, it is desirable that materials be at least partly from recycled materials, thus avoiding expenditure of further resources and providing a market for recycled materials.

Also, as discussed above, there are advantages to forming plastic or plastic-like materials through extrusion processes over injection molding process such as 1) lower capital cost for extrusion machinery, 2) lower capital cost for dies/molds, 3) higher length to diameter ratio (L/D) for extrusion process which provides various advantages like increased output rate, lower melt temperatures, less pressure and temperature variations and improved mixing, 4) higher production as there can be constant output with extrusion compared to intermittent production with injection molding because injection molding process is limited by cycle time, 5) highly viscous materials can be handled with extrusion process while in injection molding lower viscosity of the material is necessary to be able to fill the molds. 6) multi-layered products can be manufactured using co-extrusion process which is not feasible with injection molding process.

The present invention is a synthetic building material in which 65%-90% by weight of the material is mineral filler such as limestone, or dolomite, talc, silica and flyash, (but limestone will be the most preferred), in combination with 10%-35% by weight of thermoplastic resin, specifically recycled polyethylene, to produce through extrusion a synthetic building material for roofing or siding. It is possible that the extruded panels be configured with textures that give the appearance of more expensive materials such as slate or wood shingles. However, the synthetic material is actually much more sturdy than slate, which is brittle, and does not involve some of the expansion and contraction problems that are involved in wood shingle constructions.

Generally the present process includes the measurement of raw materials by weight followed by the dry blending of raw ingredients. The mixture is fed to a screw extruder at a constant feed rate to extrude the material into a sheet form. The product sheet is embossed to provide a desired texture onto the surface followed by water cooling, drying and trimming to manufacture the final product. The extruded material is optionally ready to be used in a functional sense before it has cooled and dried. However, the step of embossing is preferably performed by pressing the surface with a texture pattern which gives it the appearance of slate panels, or cedar shingles or shake as an ornamental addition. This appearance can also be thought of as functional, in the sense that it allows a synthetic material to take on the appearance of non-synthetic material, when the appearance of the material can be considered as a functional aspect. For example, if a partial replacement of a damaged slate roof is to be performed, it is important in a functional sense that the new tile blend in with the originals.

As discussed above, there are special conditions that must be considered when dealing with extrusion processes. It has been found that thermoplastic resin in combination with a high proportion of mineral filler cannot be extruded through conventional extrusion processes. Conventional extrusion processes are also complicated by the introduction of high filler content into thermoplastic resin because of the viscosity differences and as well as the different flow abilities of the materials. In the present invention these complications were overcome by using a special processing stabilizer/lubricant. The processing stabilizer/lubricant could be selected from either of the group like metallic stearate, hydrocarbons, fatty acids, esters, amides fluoropolymers, silicones, and boron nitride but metallic stearates (Calcium, Zinc and/or Aluminium Stearate) will be the most preferred. The criteria for the selection of metallic stearate was on the basis of factors like thermal stability, compatibility with the polymer matrix, melting point lower than polymer processing temperatures, optimum particle size to obtain maximum dispersibility and appropriate price-performance ratio.

This processing stabilizer/lubricant agent is added at 0.5-4.0% of the formulation depending on the type and concentration of the mineral filler. It provides a lubricating effect on the polymer chains that will decrease melt viscosity and enhance polymer flow to improve dispersion and acts as a lubricant to aid in processing of a formulation with 65%-90% filler content. It also provides better surface wetting between the surface of the mineral filler and the thermoplastic resin and acts as a lubricant to aid in processing of a formulation with 65%-90% filler content.

As discussed above, the formulation for producing synthetic building materials utilizes recycled or virgin thermoplastic resin. Recycled thermoplastic resins are highly prone to degradation during reprocessing. In the present invention, one reason for the balance of proportions of the components is that the high mineral filler content compared to the thermoplastic resin causes the thermoplastic resin to be enclosed by mineral filler, which reduces the thermoplastic resin's chances for degradation.

The formulation of synthetic material of this type can contain a significant amount of moisture, which inhibits the process to make a smooth synthetic building material for roofing or siding. High moisture content in the formulation results in steam being produced during processing and causes too many voids on the surface of the synthetic building material produced. The present invention combats this disadvantage by adding desiccant/moisture absorbent. By using the desiccant, pre-conditioning (de-moisturizing) of the mineral filler is not required. The desiccant used is preferably metallic (calcium and or magnesium) oxide. It does not react with any of the ingredients in the formulation but absorbs the moisture from the formulation.

As discussed above, an ideal building material has many qualities, which the synthetic building material 10 of the present invention possesses. The synthetic building material 10 disclosed here is moderate in weight making it potentially suitable for many construction uses as well as reducing its transport costs to market.

The present synthetic building material 10 has demonstrated excellent characteristics of durability, impact resistance and flexibility making it potentially suitable for many construction uses including roofing or siding.

As mentioned above, the International Council of Building Officials (ICBO) is a body that sets standards for building materials. These standards include a number of parameters, which are shown in the chart below, along with the results obtained by the testing the present synthetic building material 10.

The following tests were performed for ICBO approvals:

| Test | Result | Test Procedures |
|---|---|---|
| Weatherometer Test | Weather exposure testing, light, | ASTM G-23 |
| | water, heat. Passed for 2000 hrs. No | |
| | evidence of surface cracking, | |
| | blistering, flaking, chalking, color | |
| | change was observed. | |
| Tensile strength and Elongation | 349 lbs/in² control; 345 lbs/in² after | ASTM D638 |
| | weathering | |
| Flexural-strength Test | 784 lbs/in² control; 828 lb/in² after | ASTM D790 |
| | weathering | Procedure A, Test |
| | | Method 1 |
| Ignition Properties | No change after weathering. | UBC 26-7 |
| | Ignition after 343° C./650° F. | ASTM D 635 |
| Burn Rate | Average time of burning 5 seconds | ASTM D1929-68 |
| | before and after weathering | UBC 26-6 |
| Wind Resistance | Class B Can withstand up to 80 mph | Section 4.2 of |
| | winds | AC07 |
| Uplift-bend Test | The load required to lift the tile | Section 4.4 of |
| | must be twice its weight. RoofRoc | AC07 |
| | passed at an equivalent of three | |
| | times its weight. | |
| Penetration Test | Compliance. No tearing or cracking | Section 4.5 of |
| | after 200 lb load limits. | AC07 |
| Roof Classification Test | Class “A” fire rating - highest | Class “A” UBC 15- |
| | standard available | 2, ASTM E 108, |
| | | UL 790 |
| Temperature Cycling Test | −40° C.-82° C. with 1 hour of water | Section 4.9 of |
| | exposure - no evidence of crazing | AC07 |
| | or cracking or any sign of | |
| | deleterious surface or joint change. | |

The present invention was configured as synthetic slate which meets all of the above criteria. As discussed above, the synthetic slate includes recycled thermoplastic, mineral filler and various other additives.

In another embodiment of the invention, when these tiles are applied to a roof, the roof will have a Class ‘A’ fire rating, the highest standard in the building industry. The fire rating test was performed according to UBC 15-2, for flame spread, burning brand and intermittent flame. The high amount of inorganic mineral filler contributes to a Class ‘A’ fire resistance rating. A series of tests has been performed in order to achieve product accreditation from International Council of Building Officials (ICBO), USA. All the tests were performed according to Acceptance Criteria for special roofing systems (AC07). Details of this approval are available in evaluation report ER-6114 which is available on www.icc.org. The summary of the tests along with the results has been provided in the chart above.

This new synthetic slate look alike roofing product comprises of recycled or virgin thermoplastic resin, mineral filler, processing stabilizer/lubricant, antioxidant, UV stabilizer, flame retardant, desiccant and wax. Inorganic color pigments are also incorporated during the dry blending of raw materials in order to have a desired color of final product. Thermoplastic resin could be polyethylene (PE), polypropylene (PP) and poly vinyl chloride (PVC) but polyethylene (PE) will be the most preferred.

Mineral filler could be limestone, dolomite, talc, silica and flyash but limestone will be the most preferred. Recycled or virgin thermoplastic resin is in the concentration of 10-35% while mineral filler is in the range of 65-90%. In order to process the recycled thermoplastic resin with high concentration of mineral filler, a special processing stabilizer/lubricant was investigated. The processing stabilizer/lubricant could be selected from either of the group like metallic stearate, hydrocarbons, fatty acids, esters, amides fluoropolymers, silicones, and boron nitride but metallic stearates (Calcium, Zinc and/or Aluminium Stearate) will be the most preferred.

As discussed above the appearance of the tiles can be changed to model the appearance of slate or cedar shingles or siding. Modification to expand roofing products to cedar shakes and shingles is simply a change in the compression die or embosser to imprint the texture of cedar on the synthetic material. Modifications to expand roofing products to terra cotta tiles are simply a change in the compression die or embosser to imprint the texture of terra cotta on the synthetic material and to compress/mold/cool in a form which replicates the curved shape of terra cotta tiles. Modifications to expand synthetic building products to siding are simply a change in the compression die or embosser to imprint the desired texture of the siding on the synthetic material and the use of a tapered joint which will allow for the expansion and contraction of the material when butted end to end longitudinally.

When coloration is required for appearance, red iron oxide, yellow iron oxide and black iron oxide are used as coloring agents.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

### INDUSTRIAL APPLICABILITY

The present synthetic building material 10 is well suited for application in construction of homes and commercial building, and can be used as roofing or side paneling, and can be given the appearance of cedar shingles or terra cotta tiles.

A technical objective of this project was to develop a material and process for manufacturing Synthetic Roofing Material using high concentration of mineral filler and virgin or recycled thermoplastic resin. The objective also incorporates the maximum use of recycled waste products that would have otherwise been sent to the landfills.

The synthetic building material 10 disclosed here compares extremely well to all natural and synthetic roofing products currently available on the market. The synthetic building material 10 is better than the traditional roofing product in the following characteristics like Class A under flammability classification, durability; to withstand harsh weather conditions found in a variety of climatic conditions including ultra-violet exposure, light in weight, low smoke density rating, high flexural strength, low water absorption and less expensive; because of low cost of recycled raw materials.

The compositions of the elements in the synthetic building material 10 have been selected to ensure maximum performance of the product for the above factors. As discussed above the appearance of the tiles can be changed to model the appearance of slate or cedar shingles or siding. Modification to expand roofing products to cedar shakes and shingles is simply a change in the compression die or embosser to imprint the texture of cedar on the synthetic material. Modifications to expand roofing products to terra cotta tiles are simply a change in the compression die or embosser to imprint the texture of terra cotta on the synthetic material and to compress/mold/cool in a form which replicates the curved shape of terra cotta tiles. Modifications to expand synthetic building products to siding are simply a change in the compression die or embosser to imprint the desired texture of the siding on the synthetic material and the use of a tapered joint which will allow for the expansion and contraction of the material when butted end to end longitudinally.

When coloration is required for appearance, red iron oxide, yellow iron oxide and black iron oxide are used as coloring agents.

For the above, and other, reasons, it is expected that the synthetic building material 10 of the present invention will have widespread industrial applicability. Therefore, it is expected that the commercial utility of the present invention will be extensive and long lasting.

1. A method of production for synthetic building material, comprising:
A) providing a filler material of proportions of 65%-90% of overall composition;
B) adding thermoplastic resin of proportions of 10%-35% of overall composition; and
C) adding a processing stabilizer/lubricant;
D) extruding said material into building shapes.

2. The method of claim 1, wherein:
said processing stabilizer/lubricant is chosen from a group consisting of metallic stearate, hydrocarbons, fatty acids, esters, amides fluoropolymers, silicones, and boron nitride.

3. The method of claim 1, wherein:
said processing stabilizer/lubricant makes up 0.5-4.0% of the overall composition.

4. The method of claim 1, wherein:
said filler material is mineral filler.

5. The method of claim 4, wherein:
said mineral filler is chosen from a group consisting of limestone, dolomite, talc, silica and flyash.

6. The method of claim 1, wherein:
said thermoplastic resin is recycled thermoplastic resin.

7. The method of claim 1, wherein:
said thermoplastic resin is virgin thermoplastic resin.

8. The method of claim 1, wherein:
said thermoplastic resin is chosen from a group consisting of polyethylene (PE), polypropylene, and poly vinyl chloride (PVC).

9. The method of claim 1, wherein B further comprises:
adding desiccant/moisture absorbent.

10. The method of claim 9, wherein:
said desiccant/moisture absorbent is a metallic oxide.

11. The method of claim 10, wherein:
said desiccant/moisture absorbent is chosen from a group consisting of calcium oxide and magnesium oxide.

12. The method of claim 1, wherein:
said synthetic building material is shaped into panels for roofing.

13. The method of claim 1, wherein:
said synthetic building material is shaped into panels for siding.

14. The method of claim 1, wherein D further comprises:
forming said material into pieces having the appearance of cedar shakes, including embossing a texture into surfaces.

15. The method of claim 1, wherein D further comprises:
forming said material into pieces having the appearance of cedar shingles, including embossing a texture into surfaces.

16. The method of claim 1, wherein D further comprises:
forming said material into pieces having the appearance of terra cotta tiles, including embossing a texture into surfaces.

17. A formulation for synthetic building material comprising:
filler material of proportions of 65%-90% of overall composition;
thermoplastic resin of proportions of 10%-35% of overall composition; and a processing stabilizer/lubricant.

18. The formulation for synthetic building material of claim 17, wherein:
said processing stabilizer/lubricant is chosen from a group consisting of metallic stearate, hydrocarbons, fatty acids, esters, amides fluoropolymers, silicones, and boron nitride.

19. The formulation for synthetic building material of claim 17, wherein:
said processing stabilizer/lubricant makes up 0.5-4.0% of the overall composition.

20. The formulation for synthetic building material of claim 17, wherein:
said filler material is mineral filler.

21. The formulation for synthetic building material of claim 17, wherein:
said mineral filler is chosen from a group consisting of limestone, dolomite, talc, silica and flyash.

22. The formulation for synthetic building material of claim 17, wherein:
said thermoplastic resin is recycled thermoplastic resin.

23. The formulation for synthetic building material of claim 17, wherein:
said thermoplastic resin is virgin thermoplastic resin.

24. The formulation for synthetic building material of claim 17, wherein:
said thermoplastic resin is chosen from a group consisting of polyethylene (PE), polypropylene and poly vinyl chloride (PVC).

25. The formulation for synthetic building material of claim 17, further comprising:
desiccant/moisture absorbent.

26. The formulation for synthetic building material of claim 25, wherein:
said desiccant/moisture absorbent is a metallic oxide.

27. The formulation for synthetic building material of claim 26, wherein:
said desiccant/moisture absorbent is chosen from a group consisting of calcium oxide and magnesium oxide.

28. The formulation for synthetic building material of claim 17, further comprising:
additives chosen from the group consisting of antioxidant, UV stabilizer, flame retardant, wax, and inorganic color pigments.

29. A synthetic building material formulated for commercial extrusion processing, said material comprising:
filler material of proportions of 65%-90% of overall composition;
thermoplastic resin of proportions of 10%-35% of overall composition; and
processing stabilizer/lubricant which is chosen from a group consisting of metallic stearate, hydrocarbons, fatty acids, esters, amides fluoropolymers, silicones, and boron nitride.

30. The synthetic building material of claim 29, wherein:
said processing stabilizer/lubricant makes up 0.5-4.0% of the overall composition.

31. The synthetic building material of claim 29, wherein:
said filler material is mineral filler which is chosen from a group consisting of limestone, dolomite, talc, silica and flyash.

32. The synthetic building material of claim 29, wherein:
said thermoplastic resin is recycled thermoplastic resin

33. The synthetic building material of claim 29, wherein:
said thermoplastic resin is virgin thermoplastic resin

34. The synthetic building material of claim 29, wherein:
said recycled thermoplastic resin is chosen from a group consisting of polyethylene (PE), polypropylene and poly vinyl chloride (PVC).

35. The synthetic building material of claim 29, further comprising:
desiccant/moisture absorbent which is chosen from a group consisting of calcium oxide and magnesium oxide.

36. The synthetic building material of claim 29, further comprising:
additives chosen from the group consisting of antioxidant, UV stabilizer, flame retardant, wax, and inorganic color pigments.

37. The synthetic building material of claim 29, wherein:
said synthetic building material is shaped into panels for roofing.

38. The synthetic building material of claim 29, wherein:
said synthetic building material is shaped into panels for siding.

39. The synthetic building material of claim 29, wherein:
said material is formed into pieces having the appearance of cedar shakes, including embossing a texture into surfaces.

40. The synthetic building material of claim 29, wherein:
said material is formed into pieces having the appearance of cedar shingles, including embossing a texture into surfaces.

41. The synthetic building material of claim 29, wherein:
said material is formed into pieces having the appearance of terra cotta tiles, including embossing a texture into surfaces.
